(19) United States
(12) Patent Application Publication
(10) Pub. No.: US 2007/0024587 A1
(43) Pub. Date: Feb. 1, 2007

(54) Power saving method and apparatus for wireless optical mouse

(75) Inventor: Juh-Gua Shiau, Hsinchu City (TW)

Correspondence Address: BRUCE H. TROXELL, SUITE 1404, 5205 LEESBURG PIKE, FALLS CHURCH, VA, 22041, US

(73) Assignee: Holtek Semiconductor Inc.

(21) Appl. No.: 11/304,805

(22) Filed: Dec. 16, 2005

(30) Foreign Application Priority Data
Jul. 29, 2005 (TW) 094125712

(51) Int. Cl. G09G 5/08

(52) U.S. Cl. 345/166

(57) ABSTRACT

A power saving method and apparatus for wireless optical mouse is disclosed, the apparatus comprising: a micro control unit (MCU), for controlling the operation of a sensor integrated circuit (IC) of an optical sensor of the wireless optical mouse; a wireless transceiver module, connected to the MCU, for transmitting/receiving electronic signals to/from a corresponding wireless interface of a computer; an oscillation frequency control circuit, for switching the operation frequency of the sensor IC so as to enable the same to be defined by a RC oscillation circuit of the sensor IC while the sensor IC being in a sleep mode, and switching the operation frequency of the sensor IC so as to enable the same to be defined by a crystal oscillation circuit; a light emitting diode (LED) control circuit, for controlling the activation of a LED and thus enabling the motion of the wireless optical mouse to be detected; a sensor cell control circuit, for enabling only one of a plurality sensor cells of a sensor cell array while the sensor IC being in the sleep mode, and enabling every sensor cell of the sensor cell array while the sensor IC being in a working mode; and a mode switch circuit, for controlling the mode the sensor IC to be switched between the sleep mode and the working mode according to the output of the sensor cell control circuit.

### FIELD OF THE INVENTION

The present invention relates to a power saving method and apparatus for wireless optical mouse, and more particularly, to a wireless optical mouse with improved optical sensor, which is capable of enabling the wireless optical mouse to consume less power as it is in a sleep mode and enabling the wireless optical mouse to be waked up as soon as the same is moved, such that the wireless optical mouse has improved power saving capability and is convenient to use.

### BACKGROUND OF THE INVENTION

Currently, there are many kinds of computer mouse available on the market, which are the most popular human-machine interface used by computers as cursor-control device. There are two basic types of mice, which are mechanical mouse and optical mouse with respect to the different means of detection. A typical mechanical mouse comprises a chassis containing a ball, with a part of the ball protruding through the underside of the chassis. Unfortunately the moving parts of such a mouse can become dirty, causing the sensors to incorrectly measure ball rotation. Therefore, the optical mouse, that bounces light off that surface with sufficient roughness onto a complimentary metal-oxide semiconductor (CMOS) sensor, had gradually replaced the roll of the conventional mechanical mouse. Moreover, as the development of wireless technology, the optical mouse combining cordless convenience, i.e. the wireless optical mouse, is becoming the most popular cursor control device. Generally, a wireless optical mouse uses batteries as it power source and thus it is important to equip the wireless optical mouse with power saving features for significantly extending battery life so as to let you go months between changing batteries.

There are two power saving methods commonly adopted by prior-art wireless optical mice. The first of the two is by using a micro control unit (MCU) to issue a “power-down” signal to the sensor IC of a wireless optical mouse while enabling the MCU to enter a sleep mode, or by cutting the power of the sensor IC directly while enabling the MCU to enter a sleep mode. However, to wake up a wireless optical mouse adopting any of the aforesaid power saving method, a key of the mouse must be pressed to wake up the MCU and thereafter the MCU can either issue a command to power up the sensor IC or recover the power supply of the sensor IC. It is noted that the wireless optical mouse adapting the method can not be waked up as soon as the mouse is moved and thus it is inconvenient to use.

The second method of the two is by enabling the wireless optical mouse to enter a sleep mode after the mouse is idle for a specific period of time while keeping the sensor IC of the mouse in a working state all the time to detect any motion of the mouse so as to wake up the mouse in time. It is noted that although the mouse can be waked up by the motion of the same without the key-pressing of the first method, the sensor IC is being kept in working state continuously that it will consume more power that the first method.

Therefore, it is in need of a power saving method and apparatus for wireless optical mouse, which has improved power saving capability and is convenient to use.

### SUMMARY OF THE INVENTION

In view of the disadvantages of prior art, the primary object of the present invention is to provide a wireless optical mouse with improved optical sensor, which is capable of enabling the wireless optical mouse to consume less power as it is in a sleep mode and enabling the wireless optical mouse to be waked up as soon as the same is moved, such that the wireless optical mouse has improved power saving capability and is convenient to use.

To achieve the above object, the present invention provide a power saving apparatus for wireless optical mouse, which comprises:
a micro control unit (MCU), for controlling the operation of a sensor integrated circuit (IC) of an optical sensor of the wireless optical mouse;
a wireless transceiver module, connected to the MCU, for transmitting/receiving electronic signals to/from a corresponding wireless interface of a computer;
an oscillation frequency control circuit, for switching the operation frequency of the sensor IC to be defined by a RC oscillation circuit of the sensor IC while the sensor IC being in a sleep mode, and switching the operation frequency of the sensor IC to be defined by a crystal oscillation circuit;
a light emitting diode (LED) control circuit, for controlling the activation of a LED and thus enabling the motion of the wireless optical mouse to be detected;
a sensor cell control circuit, for enabling only one of a plurality sensor cells of a sensor cell array while the sensor IC being in the sleep mode, and enabling every sensor cell of the sensor cell array while the sensor IC being in a working mode; and
a mode switch circuit, for controlling the sensor IC to be switched between the sleep mode and the working mode with respect to the output of the sensor cell control circuit.

To achieve the above object, the present invention provide a power saving method for wireless optical mouse, which comprises the steps of:
(1)using a mode switch circuit to detect and determine whether a wireless optical mouse has stayed motionless for more than a specific period of time;
(2) sending a control signal by the mode switch circuit for enabling the wireless optical mouse to enter a sleep mode;
(3)providing a sensor array having a plurality of sensor cells while only one of the plural sensor cells being enabled by a sensor cell control circuit;
(4)using an oscillation frequency control circuit to switch the operation frequency of a sensor IC to be defined by a RC oscillation circuit of the sensor IC;
(5)controlling a light emitting diode (LED) to be activated periodically by a LED control circuit;
(6)using the mode switch circuit to detect and determine whether the wireless optical mouse has moved with respect to the output of the enabled sensor cell;
(7) sending a control signal by the mode switch circuit for enabling the wireless optical mouse to enter a working mode;
(8)enabling every sensor cell of the sensor cell array by the sensor cell control circuit;
(9)using the oscillation frequency control circuit to switch the operation frequency of a sensor IC to be defined by a crystal oscillation circuit; and
(10) controlling a light emitting diode to be activated continuously by the LED control circuit.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic view of a power saving apparatus for wireless optical mouse according to the present invention.

FIG. 2 is a flowchart depicting a power saving method for wireless optical mouse according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

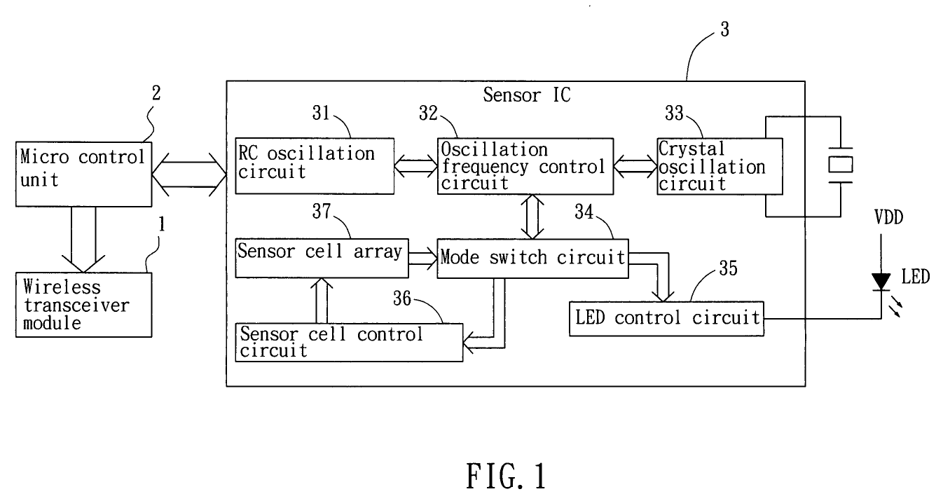

Please refer to FIG. 1, which is a schematic view of a power saving apparatus for wireless optical mouse according to the present invention. The power saving apparatus shown in FIG. 1 comprises:
a micro control unit (MCU) 2, for controlling the operation of a sensor integrated circuit (IC) 3 of an optical sensor of the wireless optical mouse;
a wireless transceiver module 1, connected to the MCU 2, for transmitting/receiving electronic signals to/from a corresponding wireless interface of a computer; and
the sensor integrated circuit (IC) 3 of the optical sensor;
wherein the optical sensor can be a complimentary metal-oxide semiconductor (CMOS), further comprising:
   an oscillation frequency control circuit 32, being a demultiplexer, for switching the operation frequency of the sensor IC 3 so as to enable the same to be defined by a RC oscillation circuit 31 of the sensor IC 3 while the sensor IC 3 being in a sleep mode, and switching the operation frequency of the sensor IC 3 so as to enable the same to be defined by a crystal oscillation circuit 33;
   a light emitting diode (LED) control circuit 35, being a logic circuit, for controlling the activation of a LED and thus enabling the motion of the wireless optical mouse to be detected;
   a sensor cell control circuit 36, being a logic circuit, for enabling only one of a plurality sensor cells of a sensor cell array 37 while the sensor IC 3 being in the sleep mode, and enabling every sensor cell of the sensor cell array 37 while the sensor IC 3 being in a working mode; and
   a mode switch circuit 34, being consisted of a timer circuit and a comparator circuit, for controlling the mode the sensor IC 3 to be switched between the sleep mode and the working mode with respect to the output of the sensor cell control circuit 36.

The power saving apparatus of the invention can significantly extend battery life so as to enable a wireless optical mouse to go months between changing batteries, and also can enable the same to be more user friendly. As the wireless optical mouse of the invention is left motionless for a specific period of time, the sensor IC 3 of the wireless optical mouse will automatically enter a sleep mode and thereafter bring along the MCU 2 to enter the sleep mode as well. As the sensor IC 3 is in sleep mode, only one sensor cell of the sensor cell array 37 is enabled and the same time that the operation frequency of the sensor IC 3 is switched so as to enable the same to be defined by the RC oscillation circuit 31 of the sensor IC 3, such that the power consumption of the optical sensor can be reduced. Nevertheless, while the sensor IC is in the sleep mode, the LED is being activated periodically and thus the output variation of the only enabled sensor cell can be detect and determine whether it has exceeded a predefined range. If the variation exceeds the predefined range, it represents that the wireless optical mouse has been moved and thus the sensor IC is being waked up and enters a working mode. The minute the sensor IC enters the working mode, every sensor cell of the sensor cell array 37 is enabled and the same time that the operation frequency of the sensor IC 3 is switched so as to enable the same to be defined by the crystal oscillation circuit 33. Thereafter, a control signal is issued to wake up the MCU 2.

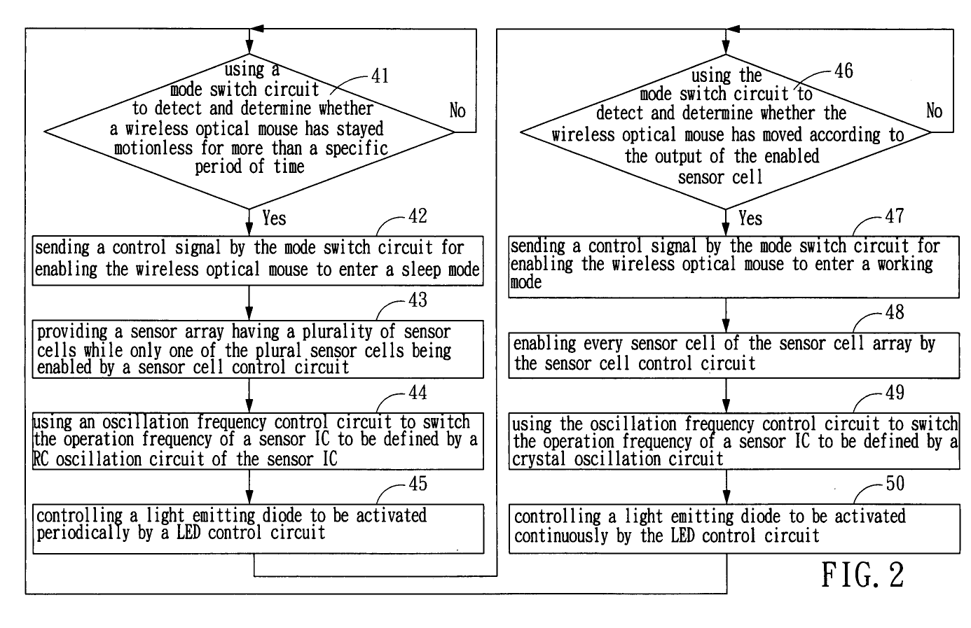

Please refer to FIG. 2, which is a flowchart depicting a power saving method for wireless optical mouse according to the present invention. The power saving method comprises the steps of:
(41) using a mode switch circuit to detect and determine whether a wireless optical mouse has stayed motionless for more than a specific period of time; if so, the flow proceeds to step (42); otherwise, the flow keep executing step (41);
(42) sending a control signal by the mode switch circuit for enabling the wireless optical mouse to enter a sleep mode;
(43) providing a sensor array having a plurality of sensor cells while only one of the plural sensor cells being enabled by a sensor cell control circuit;
(44) using an oscillation frequency control circuit to switch the operation frequency of a sensor IC to be defined by a RC oscillation circuit of the sensor IC;
(45) controlling a light emitting diode (LED) to be activated periodically by a LED control circuit;
(46) using the mode switch circuit to detect and determine whether the wireless optical mouse has moved with respect to the output of the enabled sensor cell; if so, the flow proceeds to step (47); otherwise, the flow keep executing step (46);
(47) sending a control signal by the mode switch circuit for enabling the wireless optical mouse to enter a working mode;
(48) enabling every sensor cell of the sensor cell array by the sensor cell control circuit;
(49) using the oscillation frequency control circuit to switch the operation frequency of a sensor IC to be defined by a crystal oscillation circuit; and
(50) controlling a light emitting diode to be activated continuously by the LED control circuit; and enabling the flow to go back to execute step (41) after the step (45), step (49) and step (50) are being executed completely.

From the above description, it is noted that the present invention can provide a wireless optical mouse with improved optical sensor, which is capable of enabling the wireless optical mouse to consume less power as it is in a sleep mode and enabling the wireless optical mouse to be waked up as soon as the same is moved, such that the wireless optical mouse has improved power saving capability and is convenient to use.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A power saving apparatus for wireless optical mouse, comprising:
a micro control unit (MCU), for controlling the operation of a sensor integrated circuit (IC) of an optical sensor of the wireless optical mouse;
a wireless transceiver module, connected to the MCU, for transmitting/receiving electronic signals to/from a corresponding wireless interface of a computer;
an oscillation frequency control circuit, for switching the operation frequency of the sensor IC so as to enable the same to be defined by a RC oscillation circuit of the sensor IC while the sensor IC being in a sleep mode, and switching the operation frequency of the sensor IC so as to enable the same to be defined by a crystal oscillation circuit;
a light emitting diode (LED) control circuit, for controlling the activation of a LED and thus enabling the motion of the wireless optical mouse to be detected;
a sensor cell control circuit, for enabling only one of a plurality sensor cells of a sensor cell array while the sensor IC being in the sleep mode, and enabling every sensor cell of the sensor cell array while the sensor IC being in a working mode; and
a mode switch circuit, for controlling the, sensor IC to be switched between the sleep mode and the working mode with respect to the output of the sensor cell control circuit.

2. The apparatus of claim 1, wherein the oscillation frequency control circuit, the LED control circuit, the sensor cell control circuit and the mode switch circuit are arranged in the sensor IC of the optical sensor.

3. The apparatus of claim 1, wherein the optical sensor is a complimentary metal-oxide semiconductor.

4. The apparatus of claim 1, wherein the oscillation frequency control circuit is a demultiplexer.

5. The apparatus of claim 1, wherein the mode switch circuit further comprises a timer circuit and a comparator circuit.

6. The apparatus of claim 1, wherein the LED control circuit is a logic circuit.

7. The apparatus of claim 1, wherein the sensor cell control circuit is a logic circuit.

8. A power saving method for wireless optical mouse, comprising the steps of:
(A)using a mode switch circuit to detect and determine whether a wireless optical mouse has stayed motionless for more than a specific period of time;
(B) sending a control signal by the mode switch circuit for enabling the wireless optical mouse to enter a sleep mode;
(C) providing a sensor array having a plurality of sensor cells while only one of the plural sensor cells being enabled by a sensor cell control circuit;
(D) using an oscillation frequency control circuit to switch the operation frequency of a sensor IC to be defined by a RC oscillation circuit of the sensor IC;
(E) controlling a light emitting diode (LED) to be activated periodically by a LED control circuit;
(F) using the mode switch circuit to detect and determine whether the wireless optical mouse has moved with respect to the output of the enabled sensor cell;
(G)sending a control signal by the mode switch circuit for enabling the wireless optical mouse to enter a working mode;
(H)enabling every sensor cell of the sensor cell array by the sensor cell control circuit;
(I) using the oscillation frequency control circuit to switch the operation frequency of a sensor IC to be defined by a crystal oscillation circuit; and
(J) controlling a light emitting diode to be activated continuously by the LED control circuit.

9. The method of claim 8, wherein the flow of the method proceeds to step (B) while the wireless optical mouse has stayed motionless for more than the specific period of time; otherwise the flow keep executing step (A).

10. The method of claim 8, wherein the flow of the method proceeds to step (G) while the wireless optical mouse has moved; otherwise the flow keep executing step (F).

11. The method of claim 8, wherein the flow of the method goes back to execute step (A) after the step (H), step (I) and step (J) are being executed completely.
